(19) United States
(12) Patent Application Publication
(10) Pub. No.: US 2016/0309670 A1
(43) Pub. Date: Oct. 27, 2016

(54) MULTI-FUNCTIONAL FLOWERPOT

(71) Applicant: Shui-Shang Chen, Changhua (TW)

(72) Inventor: Shui-Shang Chen, Changhua (TW)

(73) Assignee: DO LIN METAL INDUSTRIAL CO., LTD., Changhua (TW)

(21) Appl. No.: 15/131,925

(22) Filed: Apr. 18, 2016

(30) Foreign Application Priority Data
Apr. 21, 2015 (TW) 104206063

(51) Int. Cl. A01G 27/02; A01G 9/02

(52) U.S. Cl. CPC A01G 27/02; A01G 9/02

(57) ABSTRACT

A multi-functional flowerpot may comprise a pot body, a tank and a plurality of supporting units. The pot body has at least a through hole formed at a bottom portion thereof, and the supporting units are configured to support the pot body to locate above the tank. More specifically, when the pot body is connected to the tank through the supporting units, a lower portion of the pot body is inserted into the tank and the position of the pot body is located above a bottom portion of the tank. Thus, when the plants cultivated in the pot body and the aquatic plants or aquatic animals raised in the tank, the excess water of the pot body can flow through the through hole into the tank.

### FIELD OF THE INVENTION

The present invention relates to a multi-functional flowerpot and more particularly to a multi-functional flowerpot that is configured to integrate gardening and aquaculture thereby maintaining the humidity of planting soil.

### BACKGROUND OF THE INVENTION

Nowadays, the flowerpot and the tank are used not only for interior design but also for ornamental effect, and the plants growing in the flowerpot can beautify the environment and improve air quality. Also, some of the styling flowerpots further have artistic values which can enhance the exchange of art and culture. Generally, a pot body of a planting flowerpot has at least a hole formed at a bottom portion thereof, and a saucer usually is placed under the flowerpot to collect excess water which flows out from the hole of the flowerpot. However, although the saucer provides a place which allows the flowerpot to discharge the excess water, it is also the place causing contaminants and the propagation of mosquitoes thereby lowering environmental hygiene and visual enjoyment.

Furthermore, in order to improve the growing environment of the plants in the flowerpot, the fertilizer and the soil conditioners are always applied to the soil carried in the pot body to supply plant nutrients essential to the growth of plants. On the other hand, a household tank always uses treated tap water for raising fishes which comprises chlorine, and the owner needs to add the water quality stabilizer and the water conditioner to remove the chlorine and accelerate the breeding of Nitrifying bacteria to consume nitrogen in the water thereby improving the water quality. However, the approaches mentioned above to improve the growing environment by adding the artificial substances can only achieve the goals in short term, and are hard to apply in long term planting and raising fishes and fulfill eco-friendly. Therefore, there remains a need for a new and improved design for a multi-functional flowerpot to overcome the problems presented above.

### SUMMARY OF THE INVENTION

The present invention provides a multi-functional flowerpot which comprises a pot body, a tank and a plurality of supporting units. The pot body has an inner space which is configured to cultivate at least a plant, and at least a through hole is formed at a bottom portion of the pot body. Also, the pot body has a flange formed at an outer periphery thereof, and a top opening is formed at a top portion of the pot body. The tank comprises a first opening formed at a top portion thereof, and the diameter of the first opening is larger than an outer diameter of a bottom portion of the pot body. Each of the supporting units has a first end and a second end which are respectively borne against a lower edge of the flange and an edge of the first opening of the tank. Also, when the pot body is connected to the tank through the supporting units, a lower portion of the pot body is inserted into the tank and the position of the pot body is located above a bottom portion of the tank.

Therefore, when the plant cultivated in the pot body and the aquatic plants or aquatic animals raised in the tank, the excess water of the pot body can flow through the through hole into the tank. Moreover, when the water level of the tank is higher than the bottom portion of the pot body, the water in the tank also can flow through the through hole into the pot body to provide the plant with required humidity.

Furthermore, the tank has a first water guiding tube and a second water guiding tube which are respectively located at two corresponding positions on a lateral wall of the tank. An outer diameter of the second water guiding tube fits within an inner diameter of the first water guiding tube, so that the second water guiding tube can be inserted into and secured in the first water guiding tube. Moreover, two water outlet holes of the first water guiding tube and the second water guiding tube are respectively covered with a first sealing cover and a second sealing cover to prevent water from flowing out of the tank. In addition, the present invention has a first annual fence which is formed in a truncated cone shape and covers around the supporting units.

In the second embodiment, the present invention comprises a shade cover, and each of the first supporting units further has a first telescopic rod and a second telescopic rod. In this embodiment, the first end and the second end are respectively formed at two ends of the first telescopic rod, and the first end is configured to bear against the flange of the pot body while the second end is connected to a lower end of the second telescopic rod. A supporting end formed at an upper end of the second telescopic rod is configured to support an inner surface of the shade cover, and the second telescopic rods are vertically secured around the pot body to hold up the shade cover. Moreover, each of the first telescopic rods and the second telescopic rods has at least a locking unit formed at a rod body thereof, and the lock units are configured to respectively fix the lengths of the first telescopic rods and second telescopic rods after adjusting the first telescopic rods and the second telescopic rods to designated lengths.

Moreover, in the second embodiment, the present invention further comprises a second annual fence which covers around the second telescopic rods.

In the third embodiment, the present invention has a plurality of single pot frames protruding from an outer edge of the tank, and each of the first supporting units has two extending pot frames respectively extending from two lateral sides of a rod body of the first supporting unit.

In summary, the present invention comprises the pot body and the tank which allows the water to flow therebetween. Through the through hole, the excess water of the pot body can flow into the tank, and the water of the tank also can flow into the soil of the pot body to keep the humidity of planting soil when the water level of the tank is higher than the bottom portion of the pot body.

### BRIEF DESCRIPTION OF THE DRAWINGS

FIG. 1 is a three-dimensional exploded view of a multi-functional flowerpot in the present invention.

FIG. 2 is a three-dimensional schematic view of the multi-functional flowerpot in the present invention.

FIG. 3 is a sectional view of the multi-functional flowerpot in the present invention.

FIG. 4 is a sectional view illustrating two tanks of the multi-functional flowerpot connected to each other in the present invention.

FIG. 5 is a schematic view illustrating a plant cultivated in a pot body and vines climbing on a first annual fence of the multi-functional flowerpot in the present invention.

FIG. 6 is a three-dimensional exploded view of a second embodiment of the multi-functional flowerpot in the present invention.

FIG. 7 is a schematic view of the second embodiment of the multi-functional flowerpot illustrating the present invention applied in greenhouse cultivation by using a shade cover.

FIG. 8 is a schematic view of the second embodiment of the multi-functional flowerpot illustrating a second annual fence applied in the present invention.

FIG. 9 is a three-dimensional schematic view of a third embodiment of the multi-functional flowerpot in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

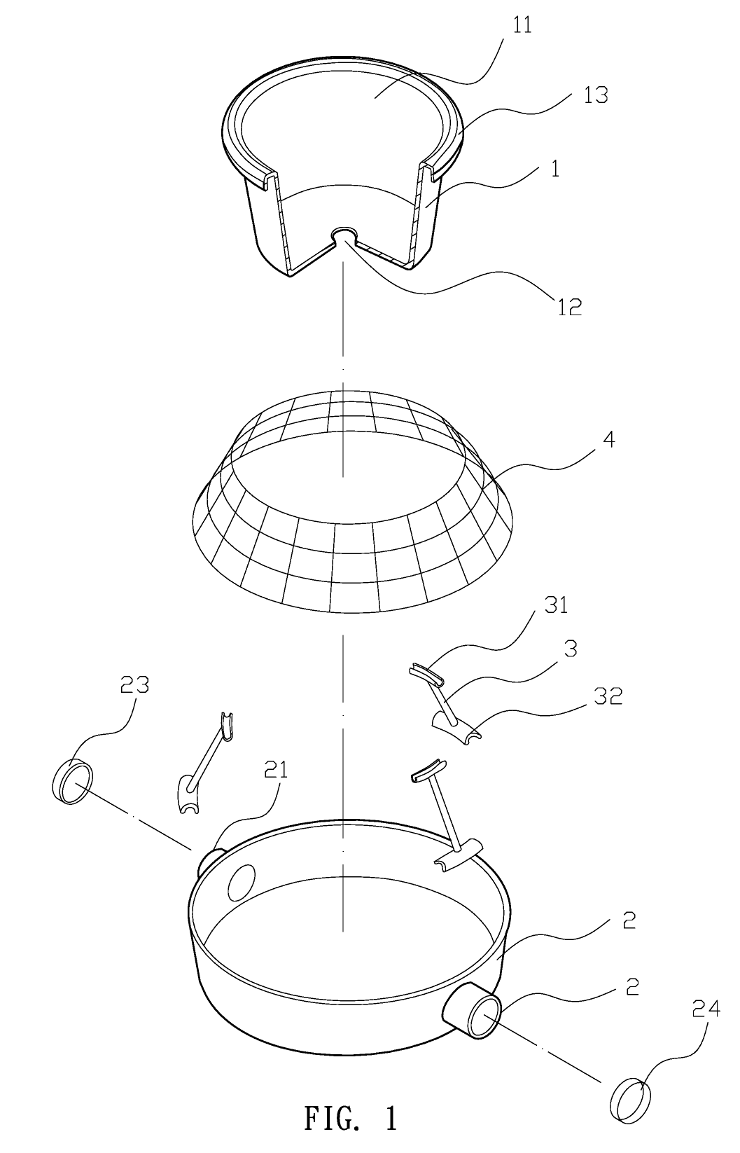

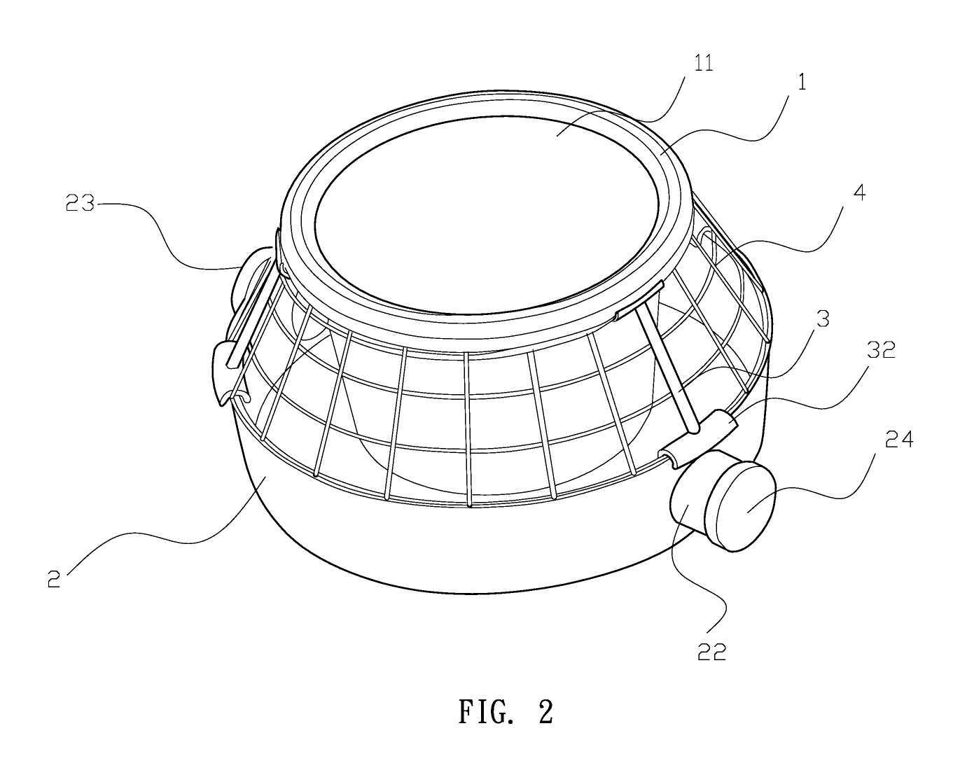

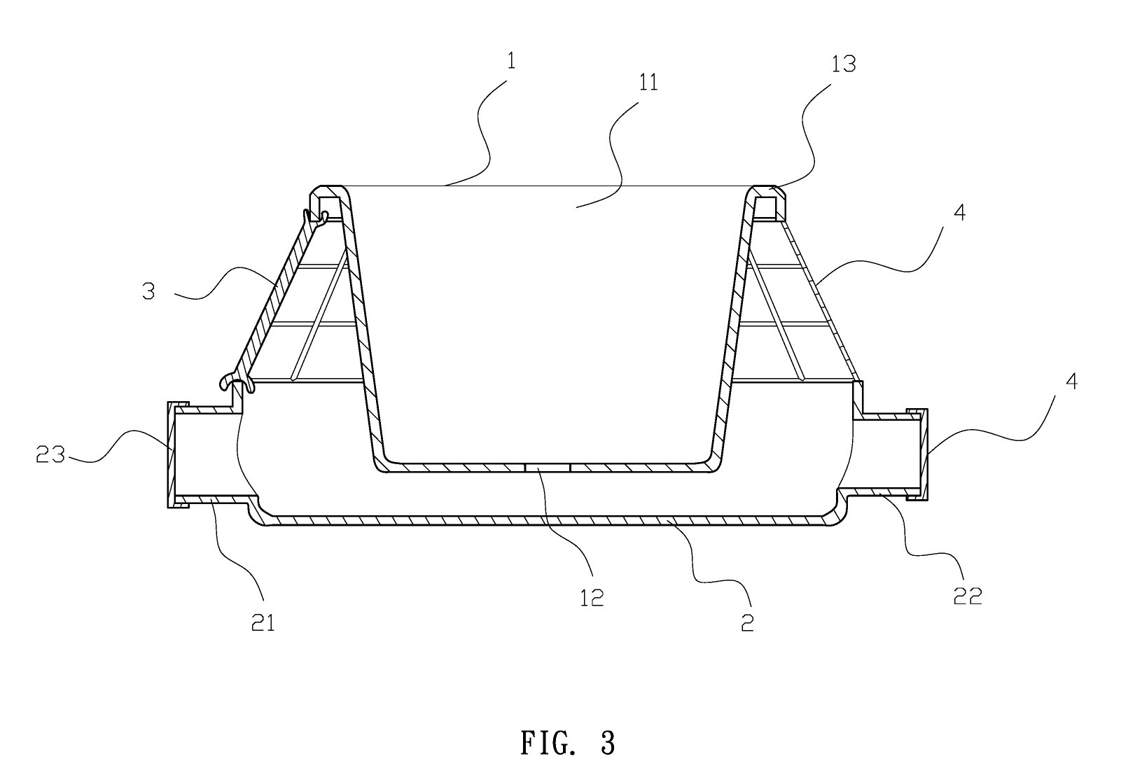

Referring to FIGS. 1 to 5, the present invention provides a multi-functional flowerpot which comprises a pot body (1), a tank (2) and a plurality of supporting units (3). The pot body (1) has an inner space (11) which is configured to cultivate at least a plant, and at least a through hole (12) is formed at a bottom portion of the pot body (1). Also, the pot body (1) has a flange (13) formed at an outer periphery thereof, and a top opening is formed at a top portion of the pot body (1). In the present invention, the flange (13) is located at an outer periphery of the top opening. The tank (2) comprises a first opening formed at a top portion thereof, and the diameter of the first opening is larger than an outer diameter of a bottom portion of the pot body (1). Each of the supporting units (3) has a first end (31) and a second end (32) which are respectively borne against a lower edge of the flange (13) and an edge of the first opening of the tank (2). Also, when the pot body (1) is connected to the tank (2) through the supporting units (3), a lower portion of the pot body (1) is inserted into the tank (2) and the position of the pot body (1) is located above a bottom portion of the tank (2) (as shown in FIG. 3).

Therefore, when the plant cultivated in the pot body (1) and the aquatic plants or aquatic animals raised in the tank (2), the excess water of the pot body (1) can flow through the through hole (12) into the tank (2). Moreover, when the water level of the tank (2) is higher than the bottom portion of the pot body (1), the water in the tank (2) also can flow through the through hole (12) into the pot body (1) to provide the plant with required humidity.

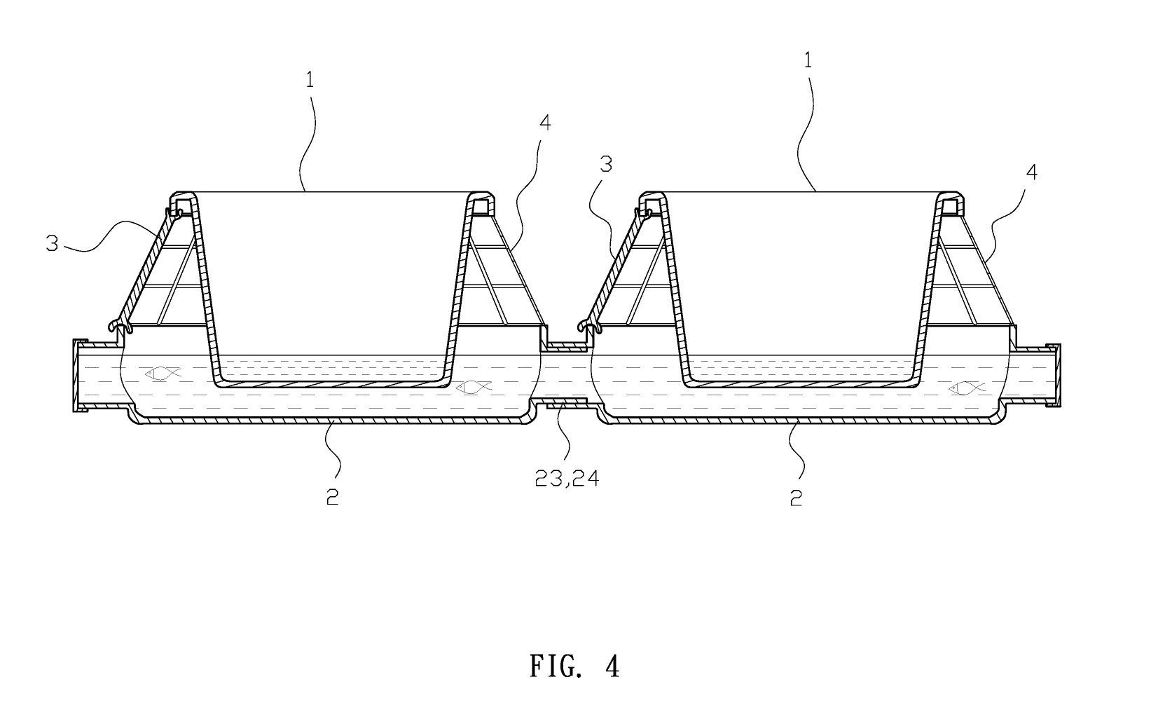

Furthermore, the tank (2) has a first water guiding tube (21) and a second water guiding tube (22) which are respectively located at two corresponding positions on a lateral wall of the tank (2). An outer diameter of the second water guiding tube (22) fits within an inner diameter of the first water guiding tube (21), so that the second water guiding tube (22) can be inserted into and secured in the first water guiding tube (21). Thus, two or more tanks (2) can be connected in sequence to achieve a large scale of aquaculture. Moreover, two water outlet holes of the first water guiding tube (21) and the second water guiding tube (22) are respectively covered with a first sealing cover (23) and a second sealing cover (24) to prevent water from flowing out of the tank (2). When the tank (2) needs to change water, the owner can open the sealing covers (23)(24) to allow water to flow out of the tank (2) through the first water guiding tube (21) and the second water guiding tube (22) thereby accomplishing the process of changing water of the tank (2) (as shown in FIG. 4).

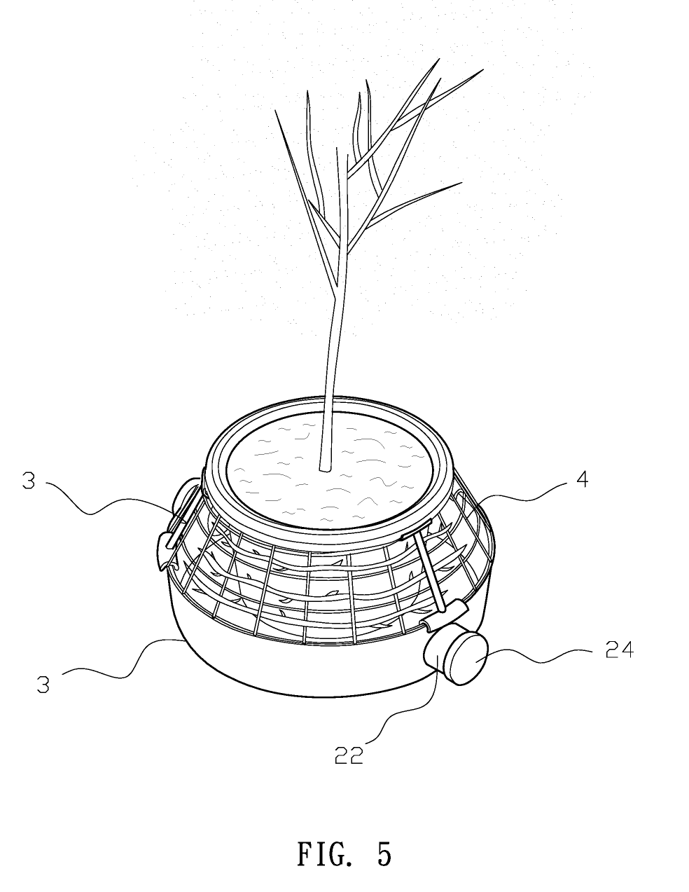

In addition, the present invention has a first annual fence (4) which is formed in a truncated cone shape and covers around the supporting units (3). Though the supporting units (3), an upper edge of the first annual fence (4) is coupled with the outer periphery of the top opening of the pot body (1) while a lower edge thereof is coupled with the edge of the first opening of the tank (2). Thus, in case that vine plants cultivated in the pot body (1), they can climb on the first annual fence (4) (as shown in FIG. 5). Also, the first annual fence (4) is configured as a cage which prevents the aquatic animals from jumping out of the tanks (2).

The present invention comprises the pot body (1) and the tank (2) which allows the water to flow therebetween. Through the through hole (12), the excess water of the pot body (1) can flow into the tank (2), and the water of the tank (2) also can flow into the soil of the pot body (1) to keep the humidity of planting soil when the water level of the tank (2) is higher than the bottom portion of the pot body (1). Moreover, since the water from the tank (2) flows through the soil in the pot body (1), the chlorine materials in the water can be removed before absorbed by roots of the plant. Additionally, the roots of the plant can extend into the water of the tank (2) to achieve water optimization, and also the aquatic animals raised in the tank (2) can eat the eggs of insects such as mosquito to further solve the pest issues causing by the flowerpot.

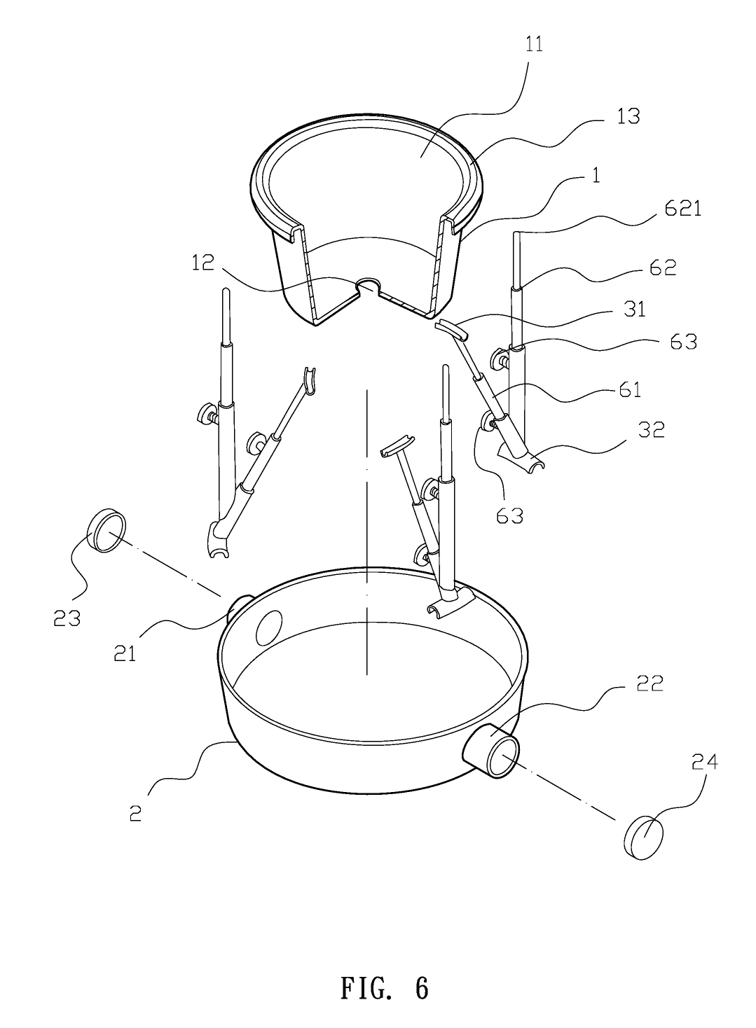

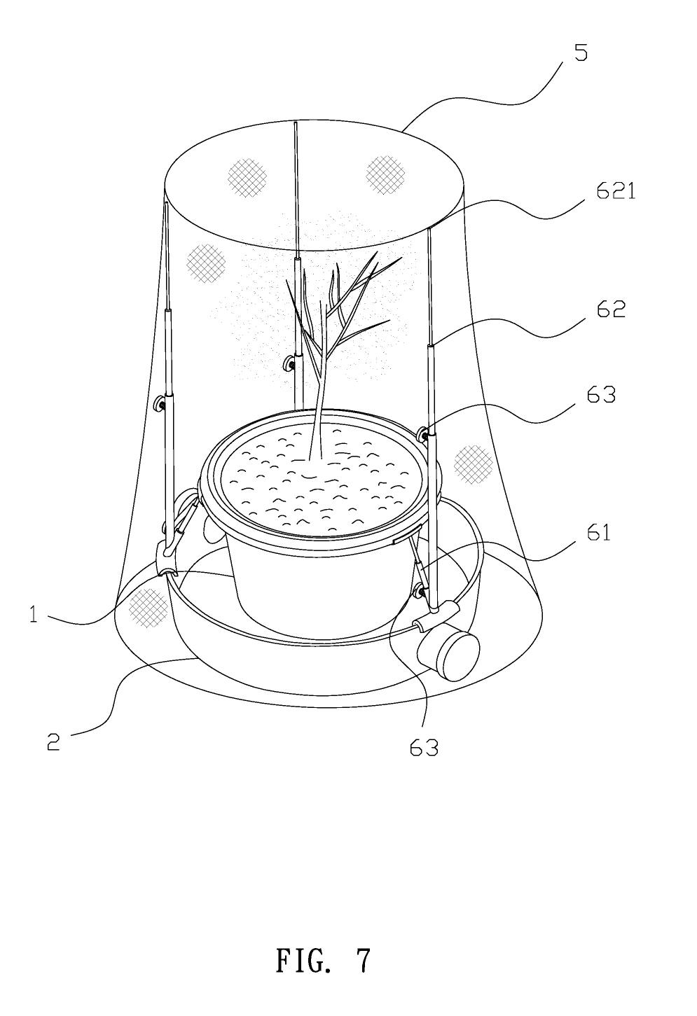

Referring to FIGS. 6 and 7, in the second embodiment, the present invention comprises a shade cover (5), and each of the first supporting units (3) further has a first telescopic rod (61) and a second telescopic rod (62). In this embodiment, the first end (31) and the second end (32) are respectively formed at two ends of the first telescopic rod (61), and the first end (31) is configured to bear against the flange (13) of the pot body (1) while the second end (32) is connected to a lower end of the second telescopic rod (62). A supporting end (621) formed at an upper end of the second telescopic rod (62) is configured to support an inner surface of the shade cover (5), and the second telescopic rods (62) are vertically secured around the pot body (1) to hold up the shade cover (5). Moreover, each of the first telescopic rods (61) and the second telescopic rods (62) has at least a locking unit (63) formed at a rod body thereof, and the lock units (63) are configured to respectively fix the lengths of the first telescopic rods (61) and second telescopic rods (62) after adjusting the rods (61)(62) to designated lengths. As a result, since the length of the first telescopic rod (61) is adjustable, the first support units (3) can be applied in different sizes of the pot body (1). Also, the shade cover (5) of the present invention has multiple functions which include blocking out insects and building a greenhouse for specific plants such as organic crops.

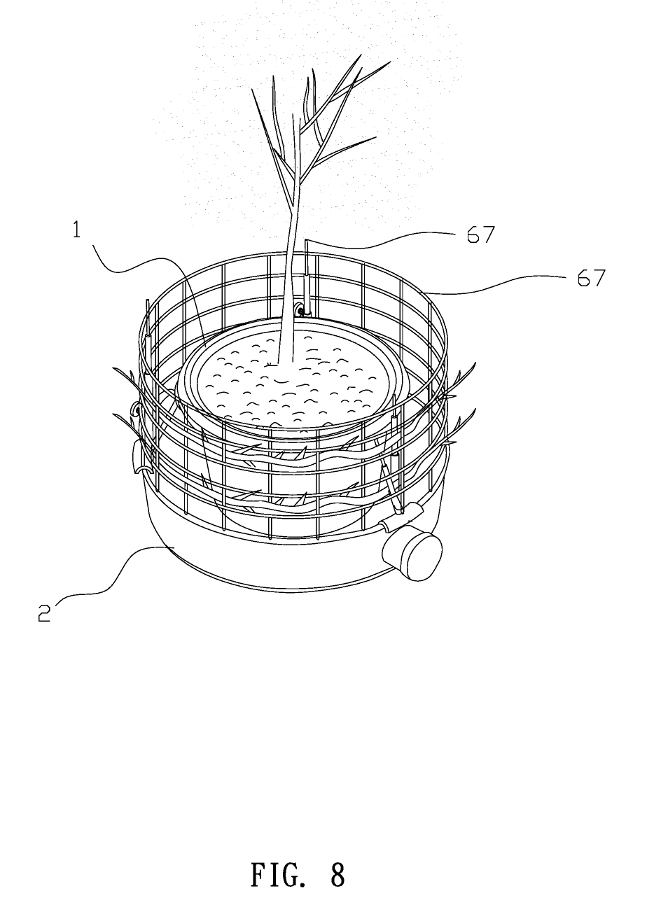

Referring to FIG. 8, in the second embodiment, the present invention further comprises a second annual fence (7) which covers around the second telescopic rods (62) and is configured to provide another climbing place for vine plants cultivated in the pot body (1).

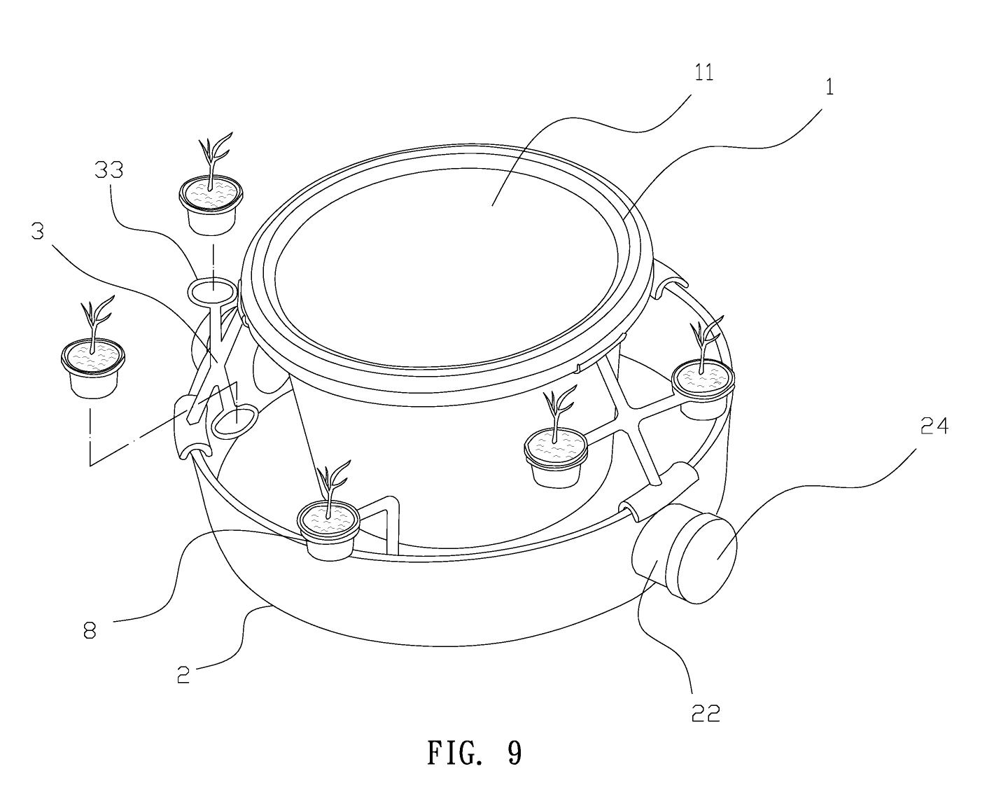

Referring to FIG. 9, in the third embodiment, the present invention has a plurality of single pot frames (8) protruding from an outer edge of the tank (2), and each of the first supporting units (3) has two extending pot frames (33) respectively extending from two lateral sides of a rod body of the first supporting unit (3). Thus, the small flowerpots can be secure on the single pot frames (8) and the extending pot frames (33) to cultivate small plants.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A multi-functional flowerpot comprising a pot body, a tank and a plurality of supporting units, wherein:
the pot body has an inner space which is configured to cultivate at least a plant, and at least a through hole is formed at a bottom portion of the pot body, and a flange is formed at an outer periphery of the pot body; and
the tank comprises a first opening formed at a top portion thereof, and a diameter of the first opening is larger than an outer diameter of a bottom portion of the pot body, each of the supporting units has a first end and a second end which are respectively borne against a lower edge of the flange and an edge of the first opening of the tank, when the pot body is connected to the tank through the supporting units, a lower portion of the pot body is inserted into the tank and the position of the pot body is located above a bottom portion of the tank.

2. The multi-functional flowerpot of claim 1, wherein the tank has a first water guiding tube and a second water guiding tube which are respectively located at two corresponding positions on a lateral wall of the tank, and an outer diameter of the second water guiding tube fits within an inner diameter of the first water guiding tube such that the second water guiding tube is configured to be inserted into and secured in the first water guiding tube, a first water outlet of the first water guiding tube and a second water outlet of the second water guiding tube are respectively covered with a first sealing cover and a second sealing cover.

3. The multi-functional flowerpot of claim 1, wherein a first annual fence formed in a truncated cone shape covers around the supporting units.

4. The multi-functional flowerpot of claim 1, wherein a shade cover hangs over the pot body and the tank, and each of the first supporting units has a first telescopic rod and a second telescopic rod which are adjustable in length, the first telescopic rod further has a first rod end and a second rod end, and the first rod end is configured to bear against the flange of the pot body while the second rod end is connected to a lower end of the second telescopic rod, a supporting end formed at an upper end of the second telescopic rod is configured to support an inner surface of the shade cover, and the second telescopic rods are vertically secured around the pot body to hold up the shade cover, each of the first telescopic rods and the second telescopic rods has at least a locking unit formed at a rod body thereof, and the lock unit is configured to fix the length of the first telescopic rod or the second telescopic rod after adjusting to designated length.

5. The multi-functional flowerpot of claim 4, wherein a second annual fence covers around the second telescopic rods.

6. The multi-functional flowerpot of claim 1, wherein a plurality of single pot frames protruding from the edge of the first opening of the tank, and each of the first supporting units has two extending pot frames respectively extending from two lateral sides of a rod body of the first supporting unit, and the single pot frames and the extending pot frames are configured to secure small flowerpots to cultivate small plants.
